(19) United States
(12) Patent Application Publication
(10) Pub. No.: US 2008/0155461 A1
(43) Pub. Date: Jun. 26, 2008

(54) DISPLAY CONTROL APPARATUS AND METHOD FOR CONTROLLING DISPLAY CONTROL APPARATUS

(75) Inventor: Eriko Ozaki, Hachioji-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/937,368

(22) Filed: Nov. 8, 2007

(30) Foreign Application Priority Data
Dec. 20, 2006 (JP) 2006-343049

(51) Int. Cl. G06F 3/048

(52) U.S. Cl. 715/784

(57) ABSTRACT

An apparatus is capable of controlling a display of a plurality of images on a display screen. The apparatus includes a scroll speed determination unit configured to determine a scroll speed, a scroll display control unit configured to scroll a display of the plurality of images on the display screen at the scroll speed determined by the scroll speed determination unit, and an instruction detection unit configured to detect an instruction issued by a user to the plurality of images displayed on the display screen. The scroll speed determination unit determines a scroll speed based on information of an image, to which an instruction detected by the instruction detection unit has been issued.

### BACKGROUND OF THE INVENTION

1. Field of the Invention

The present invention relates to an apparatus capable of controlling a display of a plurality of images displayed on a display screen and a control method for controlling the apparatus. More specifically, the present invention relates to scrolling of images displayed on a display screen and a control method therefor.

2. Description of the Related Art

In a conventional method, when a plurality of display contents (images) needs to be glanced through, a scroll function may be used to enable a user to view the entire contents by vertically and horizontally moving the display according to user input operations. Thus, display contents (images) that cannot be fully displayed within a display screen at the same time can be continuously displayed. However, in the case of viewing a large amount of display contents, it may be necessary for a user to perform a substantial amount of manual operations to find a desired content, which can impair user operability.

In this regard, Japanese Patent Application Laid-Open No. 2006-011690 discusses a display control apparatus that saves a user a time and a trouble in selecting a target content. The display control apparatus according to the Laid-open No. 2006-011690 performs display for a period of time which is changed depending on frequency of content selection since there is a difference in user's visibility between the frequently-selected content and the less frequently-selected content.

However, such a conventional display control apparatus determines a scroll speed based on whether a content has been already operated. Accordingly, such conventional display control apparatus may not change the scroll speed of a content that has never been operated by a user.

### SUMMARY OF THE INVENTION

An embodiment of the present invention is directed to a display control apparatus configured to change a scroll speed of a content that has never been operated or selected by a user.

According to an aspect of the present invention, an embodiment is directed to an apparatus capable of controlling a display of a plurality of images on a display screen. The apparatus includes a scroll speed determination unit configured to determine a scroll speed, a scroll display control unit configured to scroll a display of the plurality of images on the display screen at the scroll speed determined by the scroll speed determination unit, and an instruction detection unit configured to detect an instruction issued by a user to the plurality of images displayed on the display screen, wherein the scroll speed determination unit determines a scroll speed based on information of an image, to which an instruction detected by the instruction detection unit has been issued.

According to another aspect of the present invention, an embodiment is directed to a method for controlling a display of a plurality of images on a display screen. The method includes determining a scroll speed, scrolling a display of the plurality of images on the display screen at the determined scroll speed, and detecting an instruction issued by a user to the plurality of images displayed on the display screen, wherein the scroll speed is determined based on information of an image the instruction to which has been detected.

According to an embodiment of the present invention, a scroll speed for a content that has not been operated by a user before can be changed. Accordingly, a user's visibility in viewing a desired content can be improved.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principle of the invention.

FIG. 1 illustrates an example of a configuration of a display control apparatus according to a first exemplary embodiment of the present invention.

FIG. 2 illustrates an example of a display screen which is controlled by the display control apparatus according to the first exemplary embodiment of the present invention.

FIG. 3 is a flow chart illustrating an example of processing for determining a scroll speed according to the first exemplary embodiment of the present invention.

FIG. 4 is a flow chart illustrating an example of processing for determining a scroll speed based on currently displayed contents according to the first exemplary embodiment of the present invention.

FIG. 5 is a flow chart illustrating an example of processing for not displaying a content that does not relate to a previously focused content according to a second exemplary embodiment of the present invention.

FIG. 6 illustrates an example of a case where a content that does not relate to a previously focused content is not displayed according to the second exemplary embodiment of the present invention.

FIG. 7 is a flow chart illustrating an example of processing for determining a scroll speed based on a degree of relationship between a content to be displayed and a previously focused content, according to a third exemplary embodiment of the present invention.

FIG. 8 illustrates an example of a configuration of a display control apparatus according to a fourth exemplary embodiment of the present invention.

### DETAILED DESCRIPTION OF THE EMBODIMENTS

Various exemplary embodiments, features, and aspects of the present invention will now herein be described in detail with reference to the drawings. It is to be noted that the relative arrangement of the components, the numerical expressions, and numerical values set forth in these embodiments are not intended to limit the scope of the present invention unless it is specifically stated otherwise.

### First Exemplary Embodiment

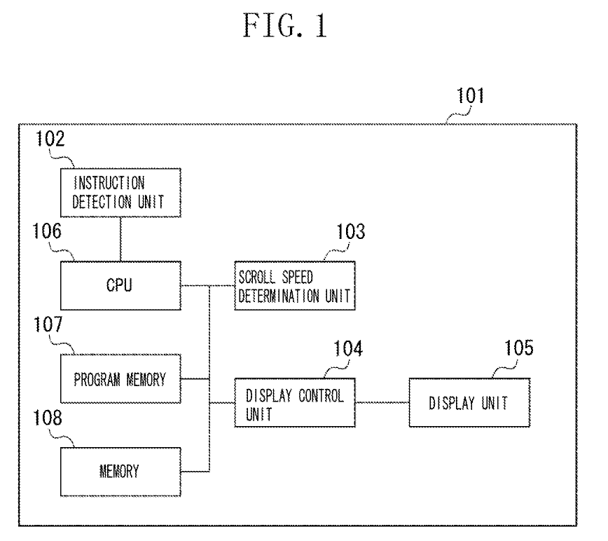

Now, a first exemplary embodiment of the present invention will be described below. FIG. 1 illustrates an example of a configuration of a display control apparatus 101 according to the first exemplary embodiment of the present invention. Referring to FIG. 1, the display control apparatus 101 includes an instruction detection unit 102, a scroll speed determination unit 103, a display control unit 104, a display unit 105, a central processing unit (CPU) 106, a program memory 107, and a memory 108.

The display control apparatus 101 performs scroll display, content selection, and content reproduction, according to a user instruction detected by the instruction detection unit 102.

When a user's operation of scrolling is detected by the instruction detection unit 102 in the case where contents cannot be fully displayed by one operation on a screen, the scroll speed determination unit 103 determines a scroll speed to change displayed contents. Embodiments of the present invention are not limited to the configuration illustrated in FIG. 1. For example, although the scroll speed determination unit 103 is shown in FIG. 1 as being separate from the CPU 106, it is noted that some or all of the functions of the scroll speed determination unit 103 as described herein may be performed by the CPU 106.

When the instruction detection unit 102 detects the scroll operation, the display control apparatus 101 moves the content display in a designated direction at a scroll speed determined by the scroll speed determination unit 103. The display control apparatus 101 repeatedly performs the above-described processing while the scroll operation is continuously detected. Thus, the user can continue scrolling the display.

The display control unit 104 controls the display so that the display contents can be scrolled at the scroll speed determined by the scroll speed determination unit 103.

The display unit 105 includes a display screen. The display screen of the display unit 105 can be a cathode ray tube (CRT) display screen, a liquid crystal display (LCD) screen, or a plasma display screen. The contents displayed on the display unit 105 is controlled by the display control unit 104.

The CPU 106 controls the entire display control apparatus 101. The program memory 107 stores a processing program that the CPU 106 executes. The memory 108 serves as a system work memory for the CPU 106. In addition, the memory 108 temporarily stores various data.

Functions of each of the above-described units and processing in flow charts described below can be implemented by the CPU 106 based on the processing program stored on the program memory 107.

Here, the “content” includes an icon indicating an attribute of a file, a folder and a thumbnail image for a still image, a moving image, audio data, and text data, in addition to content data itself.

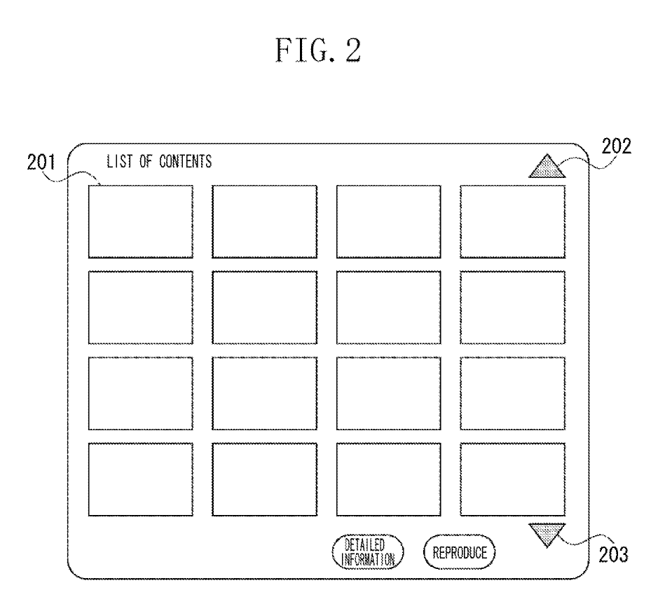

FIG. 2 illustrates an example of a display screen which is controlled by the display control apparatus 101 according to the present exemplary embodiment.

Referring to FIG. 2, a content/thumbnail 201 indicates a content itself or a thumbnail image of a corresponding content. In the case where the screen cannot display all contents at once, the user performs a scroll operation to shift displayed contents step by step.

As an example of the scroll operation by the user, when the user presses an up-button 202, which is displayed on the screen illustrated in FIG. 2, a serial scroll display of contents previous to the content/thumbnail 201 starts. When the user presses the up-button 202 again, the scroll display of the content stops.

When the user operates a down-button 203, the user can scroll contents subsequent to the content/thumbnail 201. In an embodiment, the scroll display is performed not only by a user instruction via a button displayed on the screen, but also performed when the instruction detection unit 102 detects a user instruction for a scroll display performed via a remote controller.

Now, a case will be described where, in displaying a list of contents, the scroll speed is determined (e.g., changed) based on whether a content to be displayed is associated with a content that the user has selected in the past. In such a configuration, visibility of the content that the user desires can be improved.

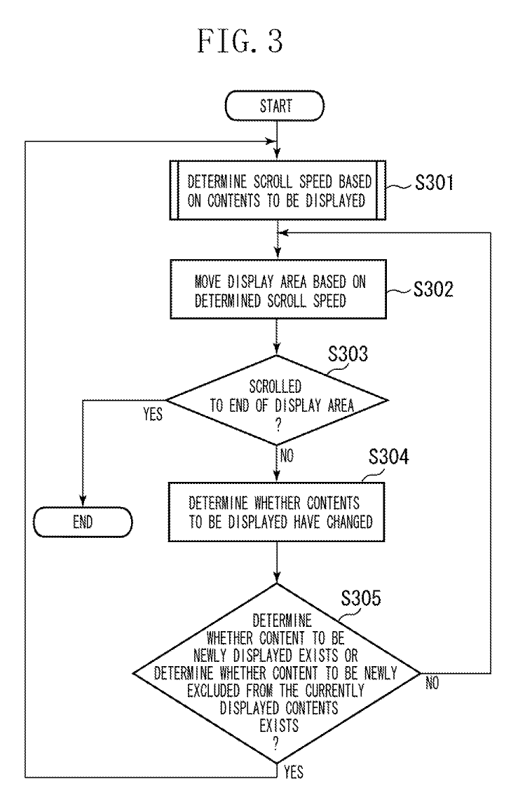

FIG. 3 is a flow chart illustrating an example of processing for decreasing the scroll speed in the case where a content associated with a focused content exists. This processing starts when an instruction for starting a scroll operation issued by the user is detected by the instruction detection unit 102.

Referring to FIG. 3, in step S301, the CPU 106 determines a scroll speed based on a currently displayed content.

In step S302, the CPU 106 moves a display area at the scroll speed determined in step S301.

In step S303, the CPU 106 determines whether the display area has come to its end.

If it is determined in step S303 that the display area has come to its end (YES in step S303), then the CPU 106 ends the processing. On the other hand, if it is determined in step S303 that the display area has not come to its end (NO in step S303), then the CPU 106 advances to step S304.

In step S304, the CPU 106 checks if contents displayed in the display area have been changed. More specifically, the CPU 106 determines whether the contents displayed in the display area have been changed after the moving of the display area in step S302. Then the CPU 106 advances to step S305.

In step S305, the CPU 106 determines whether a content to be newly displayed exists, or, determines whether a content to be newly excluded from the currently displayed contents exists.

If it is determined in step S305 that a content to be newly displayed exists or a content to be newly excluded (YES in step S305), then the CPU 106 returns to step S301. In step S301, the CPU 106 determines a scroll speed again for the change of the contents displayed in the display area.

On the other hand, if it is determined in step S305 that no content to be newly displayed exists, and at the same time, no content to be newly excluded(NO in step S305), then the CPU 106 returns to step S302. In step S302, the CPU 106 moves the display area at the current scroll speed.

The CPU 106 repeats the processing until the scroll operation is completed at the end of the display area in step S303. In addition, also when the instruction detection unit 102 detects an end of the scroll operation, the processing ends.

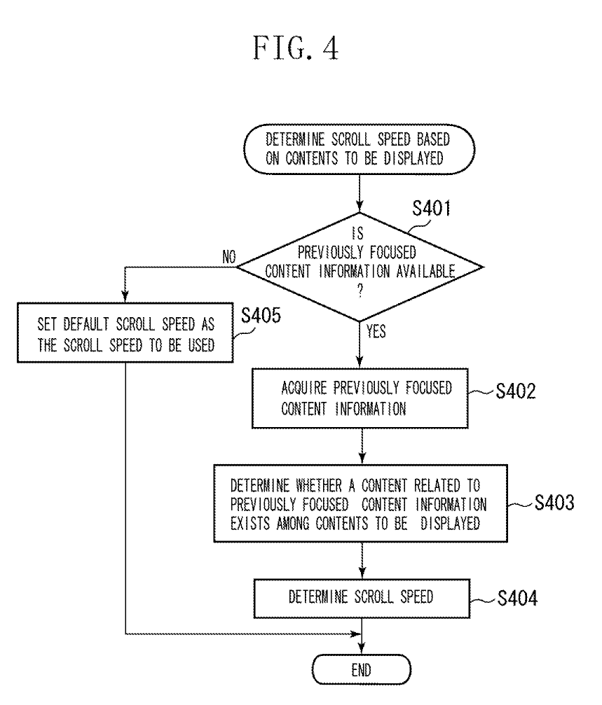

FIG. 4 is a flow chart illustrating an example of processing for determining a scroll speed based on the currently displayed contents in step S301 in FIG. 3.

Referring to FIG. 4, in step S401, the CPU 106 determines whether information about previously focused content is available.

If it is determined in step S401 that no information about previously focused content is available (NO in step S401), then the CPU 106 advances to step S405. In step S405, the CPU 106 determines that the previously provided default scroll speed is to be used as the scroll speed. Then, the CPU 106 ends the processing. On the other hand, if it is determined in step S401 that information about previously focused content is available (YES in step S401), then the CPU 106 advances to step S402. In step S402, the CPU 106 acquires information about the previously focused content.

The previously focused content is determined based on a previous user operation such as viewing of detailed information and reproduction thereof. The information about the previously focused content is stored in a storage unit included in the scroll speed determination unit 103.

In step S403, the CPU 106 determines whether a content including information related to the information about the previously focused content acquired in step S402 exists among contents to be displayed in the display area.

In step S404, the CPU 106 determines the scroll speed based on a result of the determination in step S403.

In the present exemplary embodiment, if it is determined in step S403 that a content including information related to the information about the previously focused content acquired in step S402 exists (YES in step S403), then the CPU 106 determines a relatively low scroll speed in step S404.

As described above, in the present exemplary embodiment, the scroll speed is determined not only based on whether a content related to a previously focused content exists but also the scroll speed can be changed according to an amount of the related content. For example, the scroll speed is decreased when a number of displayed related contents is large.

As described above, in the present exemplary embodiment, the scroll speed is decreased when a content related to a previously focused content exists. However, alternatively, the scroll speed can be increased with respect to a content that does not relate to a previously focused content.

In this case, the processing until determining whether a content including information related to information about a previously focused content exists (step S403) is the same as described above. However, in step S404, in determining a scroll speed, the CPU 106 determines whether the content to be displayed is the content that does not relate to the previously focused content. In this case, as described above, the CPU 106 increases the scroll speed of the content that does not relate to the previously focused content.

Thus, the display time of the content that does not relate to the previously focused content can be made shorter than the display time of the content related to the previously focused content. Accordingly, the visibility of the content related to the previously focused content can be increased.

In the present exemplary embodiment, the number of the previously focused contents is not described. However, if a plurality of previously focused data exists, the CPU 106 can change the scroll speed of each content that relates to each of the plurality of previously focused data.

Furthermore, the information about the content previously focused by the user is updated every time a user performs an operation that indicates focusing by the user, such as an instruction for displaying detailed information or an instruction for reproducing the content. Accordingly, in the present exemplary embodiment, the CPU 106 acquires the information about the previously focused content every time a scroll operation is performed. However, if there is no change about the previously focused content, the acquisition processing can be omitted.

Here, the content information includes information about an attribute, a name, a date and time of generation of the content or a keyword that a user adds thereto. That is, the content information can be any kind of information as long as the CPU 106 can determine a relationship between the currently displayed content and the previously focused content based on the content information. Furthermore, the content information can be extracted from the content itself. For example, the CPU 106 can determine the relationship between contents based on a degree of similarity between the currently displayed content and the previously focused content.

In the present exemplary embodiment, the scroll is performed always at the speed determined by the scroll speed determination unit 103. However, the scroll speed can be gradually accelerated or decelerated in changing the scroll speed by the scroll speed determination unit 103.

In the above-described configuration, the content can be smoothly scrolled and displayed even when the scroll speed is changed.

Moreover, in the present exemplary embodiment, the CPU 106 changes the scroll speed when a content related to the previously focused content exists in a display area. However, alternatively, only the scroll speed of the content related to the previously focused content can be changed without changing the scroll speed of the entire contents.

In this case, since only the scroll speed of the content related to a previously focused content is different from the scroll speed of the entire contents, the contents related to the previously focused content can be displayed as they are overtaken by or overtake other contents, using animation display.

Here, a value previously set by the scroll speed determination unit 103 can be used for the changed scroll speed, or the scroll speed can be set by a user. Alternatively, the scroll speed can be automatically determined according to an amount of contents because the change of the scroll speed is particularly useful when the amount of the entire contents is large, for example, when the user selects an arbitrary content from among a large amount of listed contents.

As described above, according to the present exemplary embodiment, the scroll speed is changed during a scroll operation based on whether a content related to a previously focused content exists and the user can easily focus on a desired content. Thus, the visibility for the user can be improved.

### Second Exemplary Embodiment

Now, a second exemplary embodiment of the present invention will be described below. In the first exemplary embodiment, the scroll speed of the content that does not relate to a previously focused content is increased. In the second exemplary embodiment, if the scroll speed of a specific content exceeds a predetermined value, the content is not displayed in order to improve the visibility of a content desired by a user.

The display control apparatus according to the second exemplary embodiment has a configuration similar to the display control apparatus 101 according to the first exemplary embodiment (FIG. 1).

In the second exemplary embodiment, after the scroll speed is determined by the scroll speed determination unit 103 in step S301 as in the first exemplary embodiment, the content scrolled at a speed exceeding a predetermined value is set as a content that is not to be displayed. Other processing is similar to the first exemplary embodiment. Accordingly, a detailed description thereof will not be repeated here.

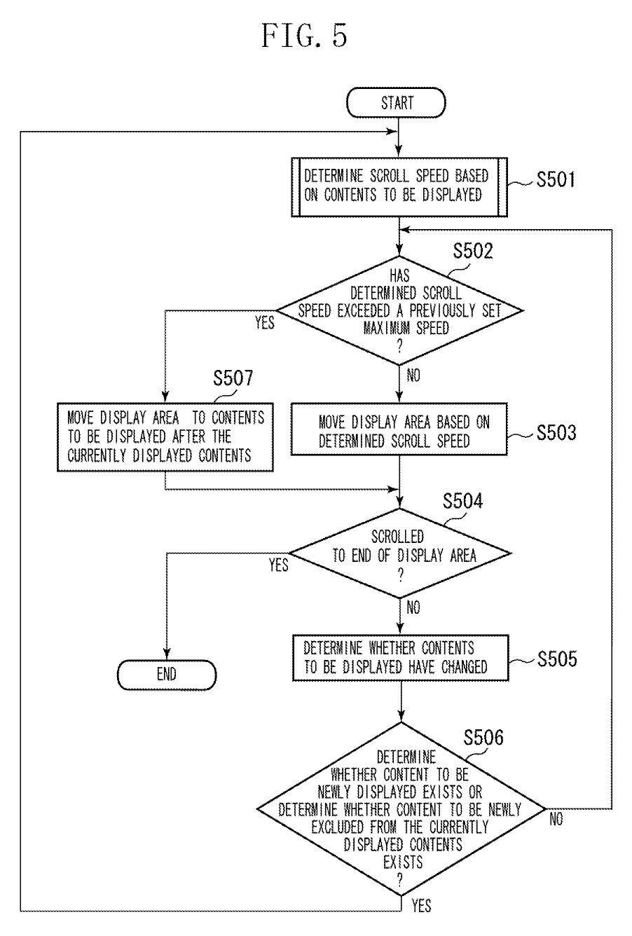

FIG. 5 is a flow chart illustrating an example of processing for not displaying a content that does not relate to a previously focused content according to the present exemplary embodiment.

Referring to FIG. 5, in step S501, the scroll speed determination unit 103 determines a scroll speed based on the contents to be displayed. In step S502, the CPU 106 determines whether the scroll speed determined in step S501 has exceeded a previously set display maximum speed.

If it is determined in step S502 that the scroll speed determined in step S501 has not exceeded the previously set display maximum speed (NO in step S502), then the CPU 106 advances to step S503 as in the first exemplary embodiment. In step S503, the CPU 106 moves the display area at the scroll speed determined in step S501.

On the other hand, if it is determined in step S502 that the scroll speed determined in step S501 has exceeded the previously set display maximum speed (YES in step S502), then the CPU 106 advances to step S507. In step S507, the CPU 106 moves the display area until contents subsequent to the originally displayed contents are displayed. Thus, the content whose scroll speed has exceeded a previously set speed, is not displayed.

Based on the non-display setting, the display control unit 104 performs control so that a content that does not relate to the previously focused content is not displayed even when the content is included in the display area as a result of a scroll operation. After step S503 or step S507, the CPU 106 advances to step S504. The processing in steps S504, S505, and S506 are similar to steps S303, S304, and S305 of first exemplary embodiment respectively. Accordingly, a detailed description thereof will not be repeated here.

In the present exemplary embodiment, the scroll speed determination unit 103 does not display a content that does not relate to the previously focused content when the scroll speed increases to a level exceeding a predetermined level. Alternatively, a user can set a threshold value of the scroll speed at which a content is not displayed.

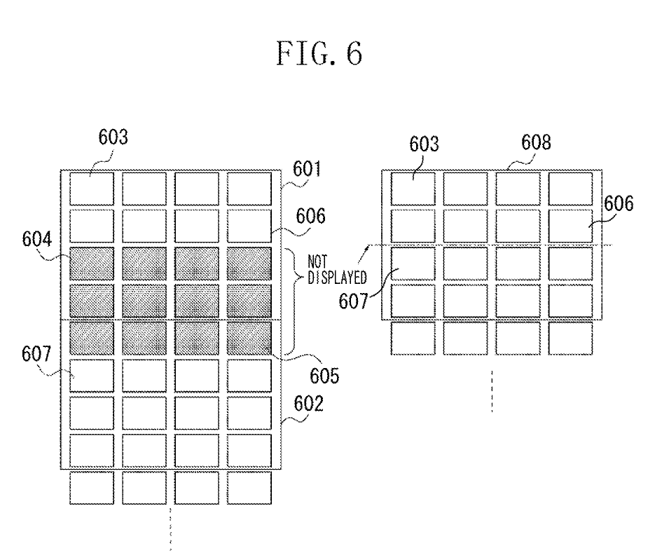

FIG. 6 illustrates an example of a case where the content that does not relate to a previously focused content is not displayed according to the present exemplary embodiment.

Referring to FIG. 6, a contents group illustrated in a left portion of FIG. 6 includes a plurality of contents while numeral 603 denotes a content.

A frame of contents 601 indicates contents displayed in one screen. When the contents 601 are displayed on the screen, if the instruction detection unit 102 detects a scroll operation for one second, contents 602 are displayed according to a result of detection.

That is, when the contents 601 are displayed on the screen, if the user starts a scroll operation and ends the scroll operation one second after the start, the displayed contents are changed to the contents subsequent to the previously displayed contents.

When the user generates an instruction for performing scroll, the scroll speed determination unit 103 determines an amount of moving the displayed contents based on one instruction, or a time period during which the instruction continues.

In the present exemplary embodiment, the displayed contents are changed by one screen, however, the display can also be changed by a predetermined number of contents. The display can be changed in any manner as long as a series of contents are serially displayed.

In the example illustrated in FIG. 6, any contents between 604 and 605 do not relate to a previously focused content. Thus, when the scroll speed determination unit 103 determines that the contents that do not relate to a previously focused content (the contents between 604 and 605) are not displayed, a content 607 is displayed subsequent to a content 606.

Contents 608 are displayed instead of the contents 601 according to the present exemplary embodiment.

In this case, the content 607 and thereafter are displayed without performing a scroll operation.

As described above, according to the present exemplary embodiment, if the scroll speed of a content to be displayed that does not relate to a previously focused content, is higher than the predetermined scroll speed, the content is not displayed.

Accordingly, the user can easily focus on a desired content. Thus, the user's visibility in viewing a content can be improved.

### Third Exemplary Embodiment

Now, a third exemplary embodiment of the present invention will be described below. In the first exemplary embodiment, the scroll speed is determined based on whether a content related to a previously focused content exists. In the third exemplary embodiment, the scroll speed is determined according to a degree of relationship with a previously focused content.

Thus, the scroll speed is gradually determined in such a manner that the scroll speed of a content having a high degree of relationship with a previously focused content is relatively low, while the scroll speed of a content having a low degree of relationship with a previously focused content is relatively high. Thus, the visibility of a content desired by a user can be improved. The display control apparatus according to the third exemplary embodiment has a configuration similar the display control apparatus 101 according to the first exemplary embodiment (FIG. 1).

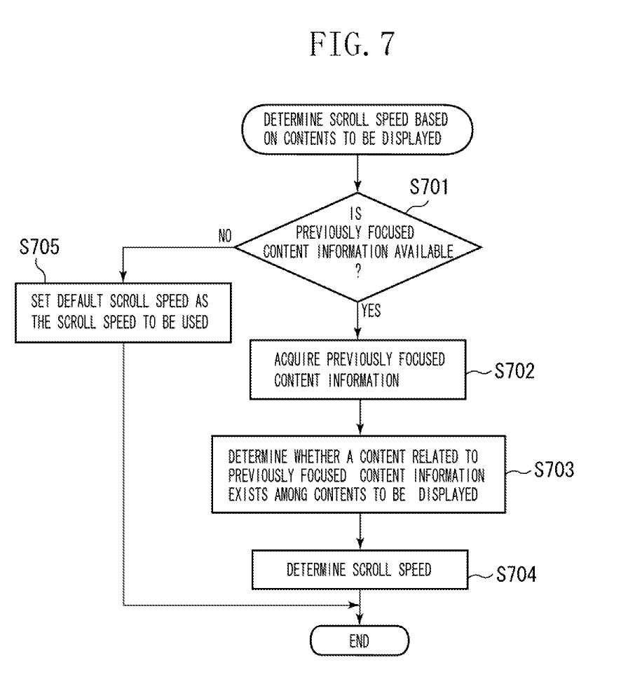

FIG. 7 is a flow chart illustrating an example of processing for changing the scroll speed based on the degree of relationship between a content to be displayed and a previously focused content, according to the present exemplary embodiment.

Referring to FIG. 7, the processing in steps S701 and S702, in which the CPU 106 acquires information about a previously focused content, and the processing in step S705, which is performed when no information about a previously focused content can be acquired, are similar to the above-described exemplary embodiments. Accordingly, a detailed description thereof will not be repeated here.

In step S703, the CPU 106 determines a degree of relationship between a content to be displayed and a previously focused content. In step S704, the scroll speed determination unit 103 determines the scroll speed based on a degree of relationship.

The degree of relationship between a content to be displayed and a previously focused content can be determined based on a degree of similarity of meta data included in the content information. The degree of relationship is determined to be high if an amount of similar meta data is large. Alternatively, the degree of relationship can be determined based on a degree of similarity of information extracted from the contents themselves.

Further, the display control apparatus 101 can include a content relationship determination unit configured to determine a degree of relationship between contents. The degree of relationship between each yet-to-be displayed content and a previously focused content can be acquired in a separate process from the main process in parallel. Alternatively, the degree of relationship can be previously acquired all the time up to a predetermined amount of subsequent scroll.

In the present exemplary embodiment, the scroll speed of the content having a higher relationship with a previously focused content is made lower so that the display time for the content having a higher relationship is longer. However, according to a display purpose, the scroll speed of the content having a higher relationship can be made shorter. Such a configuration can be useful in a case where a user desires to continuously select contents of a different category or different meta data. This configuration is also useful in searching for a content when it can be determined that the content related to a content determined to be unnecessary after referring to detailed information, is also unnecessary.

The setting for changing the scroll speed can be performed by the user via the instruction detection unit 102. Alternatively, the setting for changing the scroll speed can be automatically performed based on a user operation.

As described above, according to the present exemplary embodiment, the scroll speed is changed based on a degree of relationship between a content to be displayed and a previously focused content. Thus, a user can easily focus on a desired content. Accordingly, the visibility of a content can be improved.

### Fourth Exemplary Embodiment

Now, a fourth exemplary embodiment of the present invention will be described below. In the fourth exemplary embodiment, when the scroll speed has been changed according to the above-described exemplary embodiments, if the change of the scroll speed does not exert a sufficient effect, the changed scroll speed is made invalid.

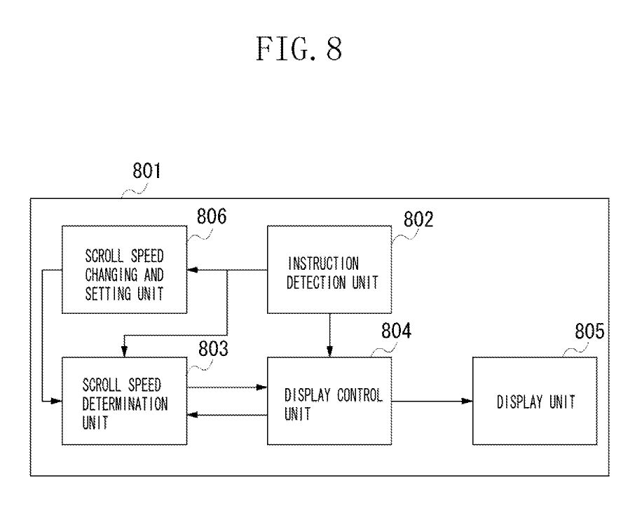

FIG. 8 illustrates an example of a configuration of a display control apparatus 801 used in this case according to the present exemplary embodiment.

Referring to FIG. 8, a scroll speed change setting unit 806 performs processing for setting the changed scroll speed invalid.

An instruction detection unit 802, a scroll speed determination unit 803, a display control unit 804, and a display unit 805 correspond to the instruction detection unit 102, the scroll speed determination unit 103, the display control unit 104, and the display unit 105 illustrated in FIG. 1, respectively.

When the instruction detection unit 802 detects an instruction for setting the changed scroll speed invalid issued by a user, the scroll speed change setting unit 806 sends the instruction for invalidating the changed scroll speed, to the scroll speed determination unit 803.

Alternatively, the scroll speed change setting unit 806 can instruct the scroll speed determination unit 803 in advance not to determine a scroll speed. Yet alternatively, the scroll speed change setting unit 806 can instruct the scroll speed determination unit 803 to invalidate the once determined scroll speed, or instruct the display control unit 804 to invalidate the changed scroll speed.

In addition, the changed scroll speed can be automatically invalidated if an amount of the content to be displayed is small, without requiring the user to perform a setting for invalidating the changed scroll speed or canceling the once determined scroll speed.

In this case, the scroll speed change setting unit 806 determines whether the change of the scroll speed is useful based on the amount of contents to be displayed.

Alternatively, the scroll speed change setting unit 806 can set whether the change of the scroll speed is useful based on a condition previously set by the user.

For example, in the case where the contents are arranged in an order of date and time, the date and time can be specified by the user as the condition to determine whether the scroll speed change is valid. Thus, in this case, the scroll speed change can be made effective only for recently generated contents while the speed change can be made invalid for old contents.

In addition, a setting can be made as to whether the scroll speed change is applied to a current scroll operation, whether the scroll speed change is applied to all the contents in the current list of contents, and whether the setting of the scroll speed change is maintained effective until the setting is further changed.

Alternatively, the user can previously set a range of the scroll speed which is to be determined, to the scroll speed determination unit 803. Yet alternatively, an effective range of the determined scroll speed can be set at a later time or, the user can set an effective range of the scroll speed change to the display control unit 804. Further, the display control apparatus 801 can include a user recognition unit configured to perform a setting as to an amount of the scroll speed change and whether the scroll speed is to be cancelled, per each user. 106 Furthermore, the display control apparatus 801 can include a time measuring unit configured to cancel the scroll speed change after given time elapses.

As described above, according to the present exemplary embodiment, it can be set during a scroll operation whether to invalidate a changed scroll speed. Only when the visibility of the contents can be increased to a sufficient level with a specific scroll speed, the scroll speed is changed based on a relationship with a previously focused content.

Thus, it can be prevented that the user meaninglessly changes the scroll speed. Accordingly, a scroll operation useful for the user can be implemented.

As described above, according to the described exemplary embodiments, the scroll speed can be changed during a scroll operation according to whether a content related to a previously focused content exists. Thus, a use can easily focus on a desired content. Accordingly, the visibility in viewing a content can be improved.

### Other Exemplary Embodiments

Embodiments of the present invention can be implemented in a system, an apparatus, a method, a program, or a storage medium storing the program, for example. More specifically, embodiments of the present invention can be applied to a system including a plurality of devices and to an apparatus that includes one device.

The present invention can be implemented by directly or remotely supplying a program of software implementing functions of the above-described exemplary embodiments (in the exemplary embodiments, the program corresponding to the processing performed according to the flow charts in the drawings) to a system or an apparatus and reading and executing supplied program codes with the system or a computer of the apparatus.

Accordingly, the program code itself, which is installed to the computer for implementing the functional processing of the present invention with the computer, implements the present invention. That is, the present invention also includes the computer program implementing the functional processing of the present invention.

Accordingly, the program can be configured in any form, such as object code, a program executed by an interpreter, and script data supplied to an OS.

As the recording medium for supplying such program code, a floppy disk, a hard disk, an optical disk, a magneto-optical disk (MO), a compact disk-read only memory (CD-ROM), a CD-recordable (CD-R), a CD-rewritable (CD-RW), a magnetic tape, a nonvolatile memory card, a ROM, and a digital versatile disk (DVD) (a DVD-read only memory (DVD-ROM) and a DVD-recordable (DVD-R)), for example, can be used.

The above program can also be supplied by connecting to a web site on the Internet by using a browser of a client computer and by downloading the program from the web site to a recording medium such as a hard disk. In addition, the above program can also be supplied by downloading a compressed file that includes an automatic installation function from the web site to a recording medium such as a hard disk. The functions of the above embodiments can also be implemented by dividing the program code into a plurality of files and downloading each divided file from different web sites. That is, a World Wide Web (WWW) server and a file transfer protocol (FTP) server for allowing a plurality of users to download the program file for implementing the functional processing constitutes the present invention.

In addition, the above program can also be supplied by distributing a storage medium such as a CD-ROM and the like which stores the program according to the present invention after an encryption thereof; by allowing the user who is qualified for a prescribed condition to download key information for decoding the encryption from the web site via the Internet; and by executing and installing in the computer the encrypted program code by using the key information.

In addition, the functions according to the embodiments described above can be implemented not only by executing the program code read by the computer, but also implemented by the processing in which an OS or the like carries out a part of or the whole of the actual processing based on an instruction given by the program code.

Further, in another aspect of the embodiment of the present invention, after the program code read from the recording medium is written in a memory provided in a function expansion board inserted in a computer or a function expansion unit connected to the computer, a CPU and the like provided in the function expansion board or the function expansion unit carries out a part of or the whole of the processing to implement the functions of the embodiments described above.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2006-343049 filed Dec. 20, 2006, which is hereby incorporated by reference herein in its entirety.

What is claimed is:

1. An apparatus capable of controlling a display of a plurality of images on a display screen, the apparatus comprising:
a scroll speed determination unit configured to determine a scroll speed;
a scroll display control unit configured to scroll a display of the plurality of images on the display screen at the scroll speed determined by the scroll speed determination unit; and
an instruction detection unit configured to detect an instruction issued by a user to the plurality of images displayed on the display screen,
wherein the scroll speed determination unit determines a scroll speed based on information of an image, to which an instruction detected by the instruction detection unit has been issued.

2. The apparatus according to claim 1, wherein the scroll speed determination unit changes the scroll speed of an image having information associated with the information of the image, to which the instruction detected by the instruction detection unit has been issued.

3. The apparatus according to claim 1, wherein the scroll speed determination unit changes the scroll speed of an image not having information associated with the information of the image, to which an instruction detected by the instruction detection unit has been issued.

4. The apparatus according to claim 1, wherein the instruction detected by the instruction detection unit is at least one of an instruction for reproducing an image and an instruction for displaying detailed information about a content.

5. The apparatus according to claim 1, wherein the display control unit does not display the plurality of images if it is determined that the scroll speed determined by the scroll speed determination unit exceeds a previously determined value.

6. The apparatus according to claim 1, wherein the scroll speed determination unit determines the scroll speed such that the scroll speed of an image including information that has a high degree of relationship with the information of the image an instruction to which has been previously detected by the instruction detection unit, becomes lower, and the scroll speed of an image including information having a low degree of relationship with the information of the image an instruction to which has been previously detected by the instruction detection unit, becomes higher.

7. The apparatus according to claim 1, wherein the information is meta data of a content indicated by the image.

8. The apparatus according to claim 1, wherein the information is information extracted from a content indicated by the image.

9. The apparatus according to claim 1, further comprising a scroll speed change invalidation setting unit configured to invalidate scroll speed change to the scroll speed determined by the scroll speed determination unit.

10. The apparatus according to claim 1, further comprising a scroll speed change effective condition setting unit configured to set an effective condition of the scroll speed determined by the scroll speed determination unit.

11. The apparatus according to claim 1, wherein the apparatus is a display control apparatus.

12. A method for controlling a display of a plurality of images on a display screen, the method comprising:
determining a scroll speed;
scrolling a display of the plurality of images on the display screen at the determined scroll speed; and
detecting an instruction issued by a user to the plurality of images displayed on the display screen,
wherein the scroll speed is determined based on information of an image, the instruction to which has been detected.

13. A computer-readable medium storing computer-executable instructions which, when executed by an apparatus capable of controlling a display of a plurality of images to be displayed on a display screen, cause the apparatus to perform operations comprising:
determining a scroll speed;
scrolling a display of the plurality of images on the display screen at the determined scroll speed; and
detecting an instruction issued by a user to the plurality of images displayed on the display screen,
wherein the scroll speed is determined based on information of an image, the instruction to which has been detected.
